(19) United States
(12) Patent Application Publication
(10) Pub. No.: US 2015/0032708 A1
(43) Pub. Date: Jan. 29, 2015

(54) DATABASE ANALYSIS APPARATUS AND METHOD

(71) Applicant: Hitachi, Ltd., Tokyo (JP)

(72) Inventors: Yasunori HASHIMOTO, Tokyo (JP); Ryota MIBE, Tokyo (JP); Kentaro YOSHIMURA, Tokyo (JP); Hirofumi DANNO, Tokyo (JP); Keishi OSHIMA, Tokyo (JP); Sadahiro ISHIKAWA, Tokyo (JP); Kiyoshi YAMAGUCHI, Tokyo (JP)

(73) Assignee: HITACHI, LTD., Tokyo (JP)

(21) Appl. No.: 14/339,829

(22) Filed: Jul. 24, 2014

(30) Foreign Application Priority Data
Jul. 25, 2013 (JP) 2013-154615

(51) Int. Cl. G06F 17/30

(52) U.S. Cl. CPC G06F 17/30315; G06F 17/30292
USPC 707/694

(57) ABSTRACT

A database analysis apparatus pays its attention to table columns more than two constituting a table among plural tables that a database holds, and analyzes automatically a dependence and a limitation condition that exist between the table columns from a tendency of appearance at the same time of data which each table column maintains, which comprises a data category calculation means to calculate a method of categorizing a data group from association rules generated from the data group of two or more table columns and an association rules reconstruction means to generate association rules of the best granularity by reconstructing the association rules based on the result of the above categorizing.

### CLAIM OF PRIORITY

The present application claims priority from Japanese application JP 2013-154615 filed on Jul. 25, 2013, the content of which is hereby incorporated by reference into this application.

### BACKGROUND OF THE INVENTION

1. Field of the Invention

The present invention relates to a database analysis apparatus and method. Especially, it relates to a method to generate the association rule between categories which comprise a plural attribute values automatically without human intervention.

2. Description of the Related Art

Related publication, JP-2000-259612-A (Patent Literature 1) describes that this art efficiently generates statistics of the attribute values concerning the transaction including item group contained in the generated rules, and the objects of calculating the association rules can be narrowed by the statistics of the attribute values in addition to the confidence and the support, when calculating the rules. (See its abstract.)

Patent Literature 1 discloses mechanism to generate the association rules concerning those attribute values from an attribute values group of table columns which a transaction table, stored in a database, keeps. Among the generated association rules above, existing dependence and limitation condition between table columns can be supposed by extracting only the association rules that have a high confidence. We can support understanding of the specifications of the database by the user by offering the supposed information above to the user.

However, the above Patent Literature 1 does not disclose the method for categorizing a group of attribute values which are kept in the table columns. More specifically, even by utilizing this technology, we cannot obtain the association rule among the attribute values which have been categorized beforehand. In addition to the fact that it is necessary to prepare a method of categorization separately, the method thereof cannot cooperate with the generation means of the association rules.

For example, if a table column contains only the attribute values of a number, by dividing the attribute value group in the specific range of such as “5 or more” and “less than 5”, it is possible to categorize the attribute value group. Moreover, in case of containing only the attribute value of time, categorization can be performed similarly. However, there is an attribute value like the character string etc. regarding which the boundary of the category division is not indiscriminately decided. In addition, in situations where there is a large amount of table columns, if a human specifies a method of categorizing all of them, man-hours work is large and not practical. Furthermore, even if the categorization method is decided in a manner that does not consider the relations between the table columns, independent of the association rules, there is no guarantee that you can generate valid association rules by the categorization method above.

### SUMMARY OF THE INVENTION

Then, the present invention aims to provide a mechanism to categorize the attribute values in generating the association rules on attribute values in the database, according to the characteristics such as confidence required for effective association rules expected. As a result, for example, in addition to the association rules between concrete 1 attribute values which were able to be extracted also with the existing technology, the association rules between the categories which consist of two or more attribute values can be automatically generated without human intervention, and can be offered to the user.

For instance, a composition listed below is adopted to achieve the above-mentioned purpose.

A database analysis apparatus is constructed, which pays its attention to table columns more than two constituting a table among plural tables that a database holds, and analyzes automatically a dependence and a limitation condition that exist between the table columns from a tendency of appearance at the same time of data which each table column maintains, comprising: a data category calculation means to calculate a method of categorizing a data group from association rules generated from the data group of two or more table columns; and an association rules reconstruction means to generate association rules of the best granularity by reconstructing the association rules based on the result of the above categorizing.

As a result, in the present invention, by combining individual association rules, the association rule with 100% probability of concurrence can be extracted.

### BRIEF DESCRIPTION OF THE DRAWINGS

FIG. 1 is an example of a block diagram of a database analysis apparatus.

FIG. 2 is an example of a flow chart explaining processing of a database analysis apparatus.

FIG. 3 is an example of an image chart illustrating a table data to be read from database.

FIG. 4A is an example of an image chart explaining the first half of processing of generating association rules from a data table.

FIG. 4B is an example of an image chart explaining the first half of processing of generating association rules from a data table.

FIG. 5 is an example of an image chart explaining the second half of processing of generating association rules from a data table.

FIG. 6 is an example of an image chart of an association rules table where values of support and confidence were filled.

FIG. 7 is an example of an image chart illustrating processing that calculates a similarity of an attribute value based on the association rules already calculated.

FIG. 8 is an example of an image chart illustrating processing that brings attribute values together with high similarity in a same category.

FIG. 9 is an example of an image chart illustrating the result of combining attribute values with high similarity in a same category.

FIG. 10 is an example of an image chart illustrating processing of reconstructing association rules.

FIG. 11 is an example of an image chart illustrating processing that selects association rules with high confidence.

FIG. 12 is an example of an image chart illustrating processing of converting data patterns association rules with high confidence, in a readily understandable format.

### DETAILED DESCRIPTION OF THE PREFERRED EMBODIMENTS

Following embodiments of the present invention are explained below in reference to the accompanying drawings.

### First Embodiment

Example of a database analysis apparatus and method will be explained in the present embodiment.

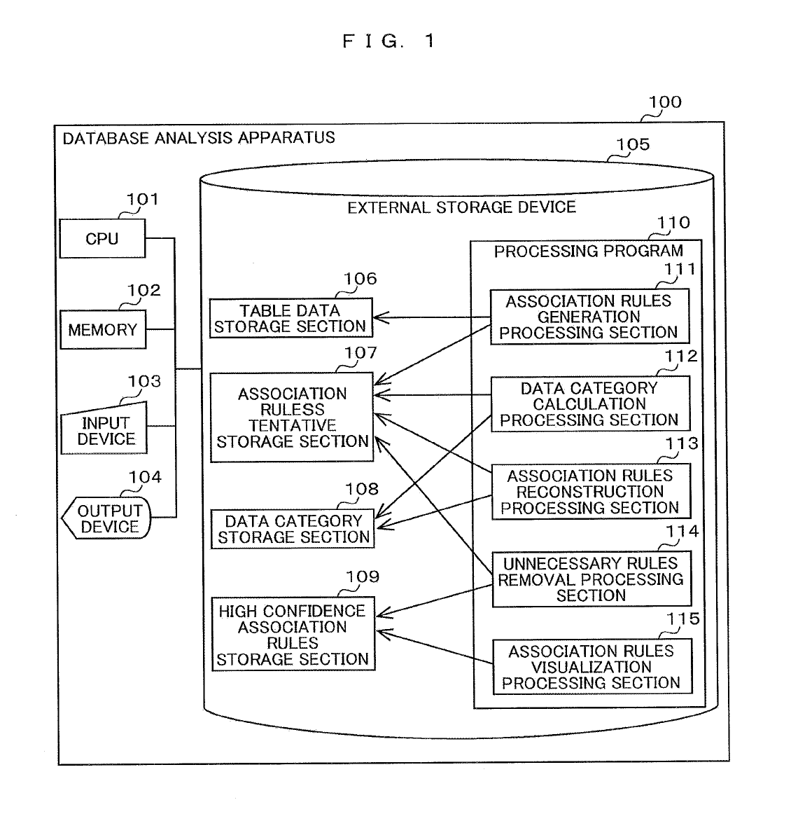

FIG. 1 is a configuration of a database analysis apparatus and method as a first embodiment.

A database analysis apparatus and method 100 holds a CPU 101, a memory 102, an input device 103, an output device 104, an external storage device 105. An external storage device 105 holds a table data storage section 106, an association rules tentative storage section 107, a data category storage section 108, a high confidence association rules storage section 109, and further a processing program 110. The processing program 110 holds an association rules generation processing section 111, a data category calculation processing section 112, an association rules reconstruction processing section 113, an unnecessary rules removal processing section 114, and an association rules visualization processing section 115.

The processing program 110 is read at the time of practice in the memory 102, and is carried out by CPU 101.

The table data of the database input through the input device 103 from the outside is written in the table data storage section 106. The association rules generation processing section 111 counts the appearance number of times of each data (and the combination thereof) while referring to the data of the database which are read from the table data storage section 106. And then calculation is added to generate association rules and they are written in the association rules tentative storage section 107. The data category calculation section 112 refers to the association rules read from the association rule tentative storage section 107, and after deciding a method of categorizing the attribute values which constitute the association rules, writes the method in the data category storage section 108. The association rules reconstruction processing section 113 reads the association rules from the association rules tentative storage section 107, and recalculates the association rules while referring to the method of categorizing the attribute values and writes the association rules in the association rules tentative storage section 107. The unnecessary rules removal processing section 114 reads the association rules from the association rules tentative storage section 107, and select solely the association rules of high confidence, then writes them in the high confidence association rules storage section 109. The association rule visualization processing section 115 reads the association rules from the high confidence association rules storage section 109, and after converting the associations rule into an easy form to visually understand, output to the output device 104.

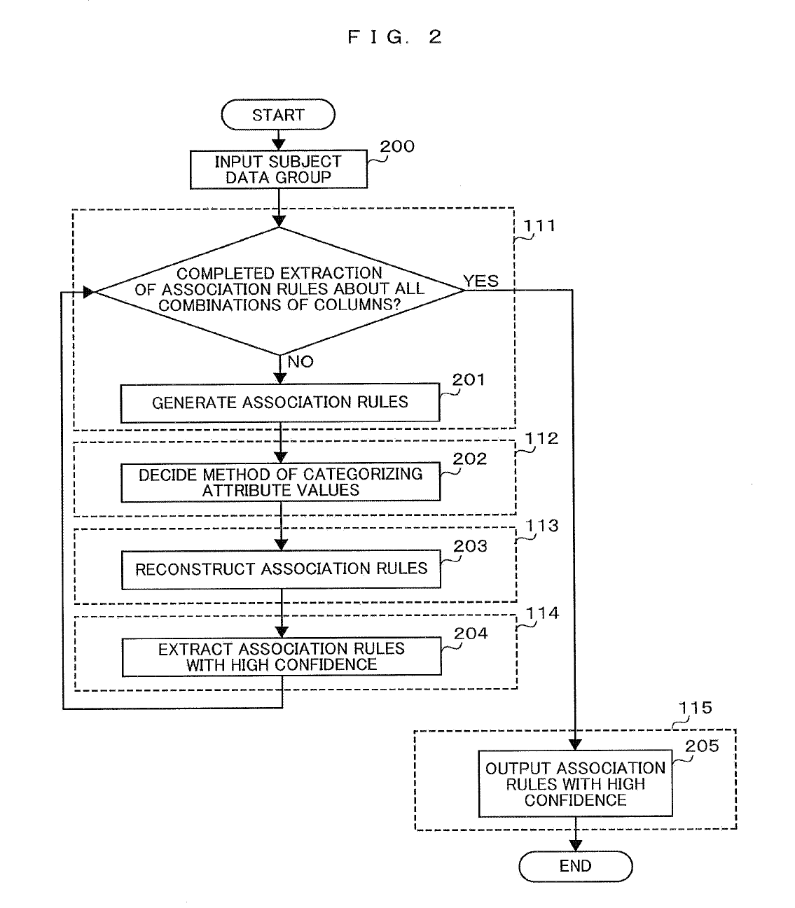

FIG. 2 is an example of a flow chart that explains processing of a database analysis apparatus of the present embodiment. Hereafter, we explain the operation of each section in FIG. 1 based on the flow chart of FIG. 2.

Step 200 is a step where the table data of the database is input as input information to the database analysis apparatus 100. The user of the apparatus executes the input operation. In step 200, the table of the database input from the input device 103 is written in the table data storage section 106.

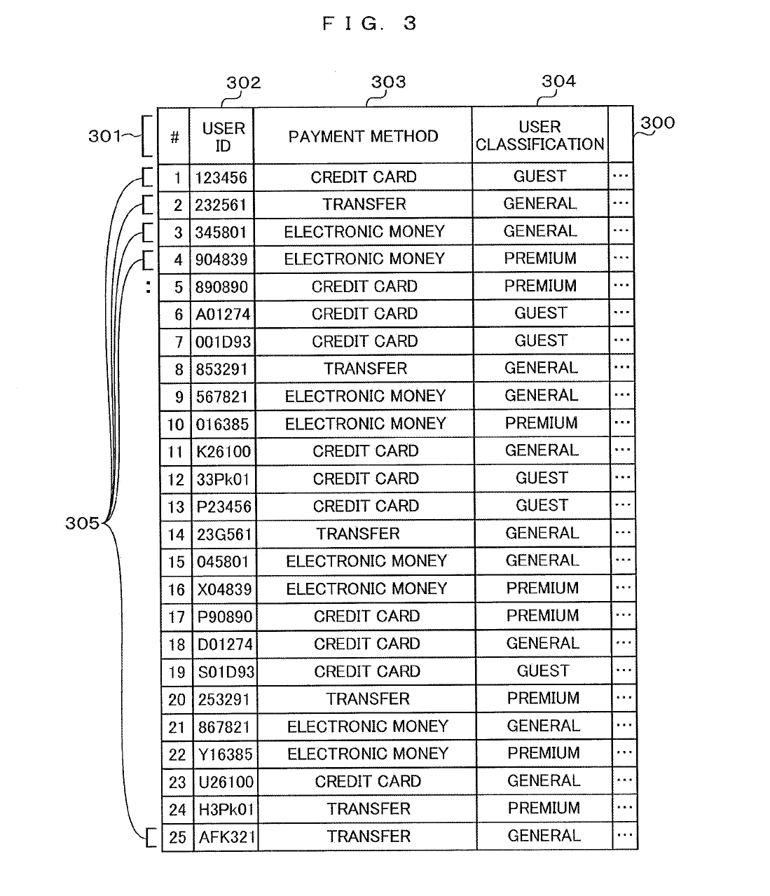

FIG. 3 is an example of an image chart where it explains the table data read from the database of the present embodiment. Here, the table data 300 to be analyzed maintains user ID 302, payment method 303, and user classification 304 as table column identifier 301. Moreover, it has 25 records 305 which are information on each line with information corresponding to each element of table column identifier 301.

The steps from 201 to 204 of the following are mechanically processed based on input information, which can be executed solely by the database analysis apparatus without human intervention.

In step 201, the association rules generation processing section 111 generates the association rules while referring to the data of the database read from the table data storage section 106, and it writes the generated rules in the association rules tentative storage section 107.

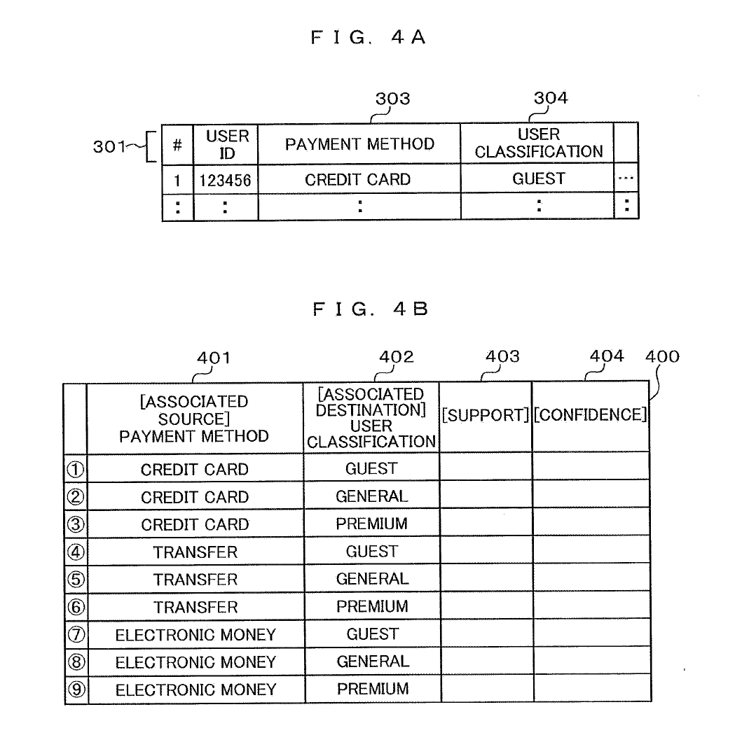

FIG. 4A is an example of an image chart where it explains the first half of processing that generates the association rules from the table data of the present embodiment.

First of all, association rules generation processing section 111 reads data 300 from the table data storage section 106, and acquires the table column identifier 301. One of the combinations of the table columns between which the association rules has not been extracted yet is selected among the elements of acquired table column identifier 301. Here, the payment method 303 and the user classification 304 are selected. Furthermore, when the table column combination is extracted, the difference of the associated source 401 and the associated destination 402 shall be considered. For instance, we judge that the following two combinations are different; one is a combination where the payment method 303 is assumed to be the associated source 401 and the user classification 304 is assumed to be associated destination 402, and the other is a combination where the user classification 304 is assumed to be the associated source 401 and the payment method 303 is assumed to be the associated destination 402.

In addition, the association rules generation processing section 111 makes the association rules table 400 corresponding to the above-mentioned combination decided as shown in FIG. 4B. Each association rule that the association rules table maintains has following information; associated source 401, associated destination 402, support 403, and confidence 404. Payment method 303 and user classification 304, which compose the above-mentioned combination, are associated with the associated source 401 and the associated destination 402 respectively.

Moreover, all patterns, which cover combination of payment method 303 and user division 304 in table data 300, shall be input beforehand as data of the association rules table. In table data 300, payment method 303 has 3 kinds of values—“credit card” and “transfer” and “electronic money”, and user classification 304 has also 3 kinds—“guest”, “general”, and “premium”. Therefore, we shall prepare 3×3=9 kinds of patterns as the data of association rules 400.

The value of support 403 and confidence 404 may not be input in the first half of processing that generates the association rules.

In addition, when the association rules of the combinations of all the table columns has already been generated at the time of initiation to execute this step, the association rule is not generated and step 115 follows.

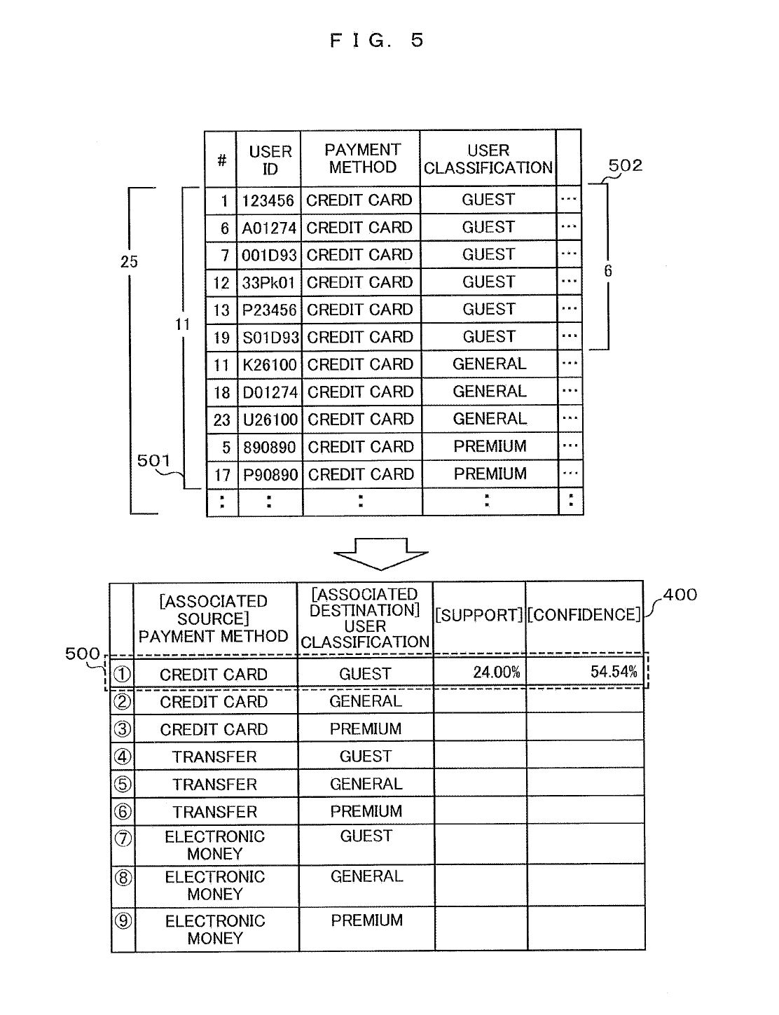

FIG. 5 is an example of an image chart where it explains the latter half of processing that generates the association rules from the table data of the present embodiment.

Firstly, the association rules generation processing section 111 selects the association rules 500, to which the values of support and confidence are not input, from the table 400. Afterwards, the record, with the value described in related origin 401 of the selected association rules 500 as a value of the table column of the associated source 401, is searched out from the table data 300. In this example, record group 501, where payment method 303 has a value of “Credit card”, is extracted. In addition, the association rules generation processing section 111 searches out the record, with the value described in the associated source 402 of the association rules 500 under selection as a value of the table column of the associated destination 402, from the above-mentioned record group 501 extracted. In the present example, record group 502, where user classification 304 has a value of “guest”, is extracted.

Afterwards, the association rules generation processing section 111 processes arithmetically the number of records included in the above-mentioned each record group. Then, it thereby calculates support 403 that is the index that shows many of data of the associated destination, and confidence 404 that is index of many of pairs of an associated source and an associated destination. Support 403 is decided by calculating the ratio of the data number of the extracted record group 502 (where each data has the same specific values concerning the associated source and the associated destination respectively) to the number of records of table data 300. In this example, because the ratio is 6 to 25 all, the support becomes (6/25)×100=24.000. Moreover, the confidence 404 is decided by calculating the ratio of the data number of the extracted record group 502(where each data has the same specific value concerning the related origin) to the data number of the extracted record group 501. In this example, because the ratio is six to 11, the support becomes (6/11)×100≈54.54%.

The same processing, as that which the association rules generation processing section 111 calculated the support and the confidence as mentioned above, is executed regarding every association rule in the association rules table 400. Subsequently, the result is stored in the association rules tentative storage section 107 and thereby Step 201 is completed.

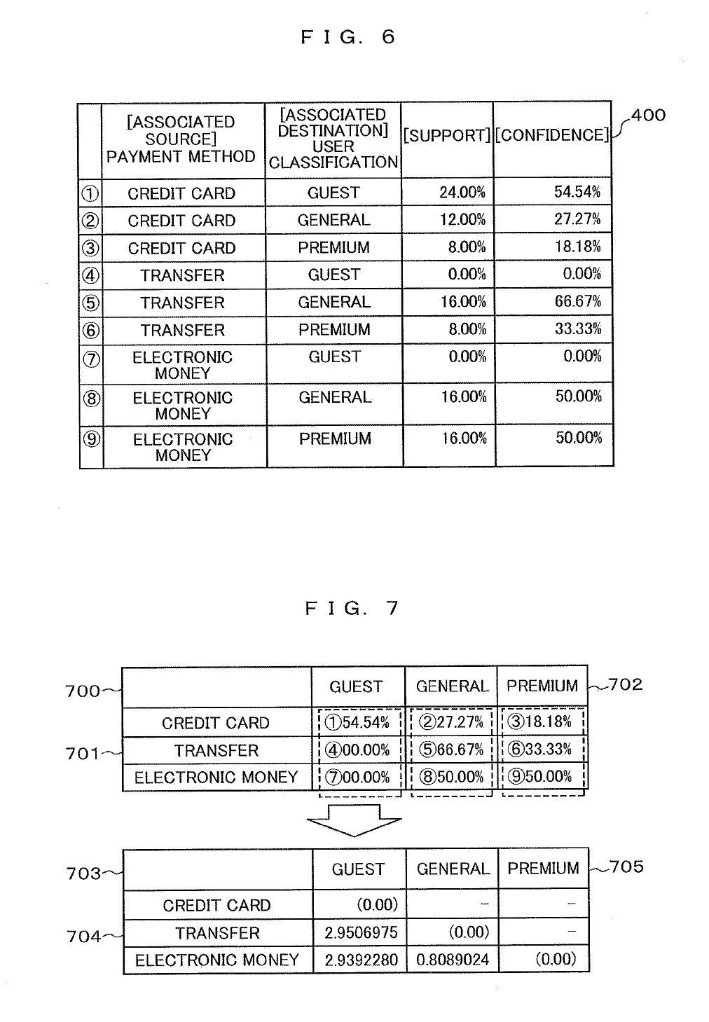

FIG. 6 is an example of an image chart of the association rules table where the columns of the support and the confidence of the present embodiment were all filled in. After step 201 in the present embodiment was completed, all items have been filled up concerning all the association rules in the association rules table 400.

In a general association rule calculation algorithm, there is something where the speed-up of the calculation processing is achieved by omitting the extraction of the association rules whose “Support” and “Confidence” are lower than a certain value. When such an algorithm is used as an alternative of step 201, the case, where “Support” and “Confidence” in FIG. 6 are not filled up, is supposed. For such a case as this, the column, where “Support” and “Confidence” are not filled in, is supplemented for instance with the value of “0.00%”, and next step follows.

In step 202, the data category calculation processing section 112 refers to the association rules read from the association rules tentative storage section 107. Then the method of categorizing the attribute values which compose the association rules is decided, and is written in the data category storage section 108.

In the present embodiment, the category of the attribute value is calculated based on the similarity of the association rules which explain each attribute value. It is assumed to be an aim to bring the attribute values, in which a similar tendency is shown, together in the same category.

FIG. 7 is an example of an image chart where it explains processing that calculates the similarity of the attribute values based on the association rules already calculated in the present embodiment.

First of all, the data category calculation processing section 112 reads the association rules table 400 from the association rules tentative storage section 107, and makes a confidence matrix 700 which maintains the value of the associated source 401 as the row label 701 and the value of the associated destination 402 as the column label 702. In addition, the data category calculation processing section 112 reads the association rules that compose the association rules table 400, and writes the value of confidence in the corresponding place in the confidence matrix 700. For example, in the association rules table 400, the value “54.54%” of confidence 404 of the association rule, which has a value of “credit card” as the associated source 401 and a value of “guest” as the associated destination 402, is written to a place, where label of row is “credit card” and label of column is “guest” in the confidence matrix 700.

Data category calculation processing section 112 completes the confidence matrix 700 by executing the above-mentioned processing of all the association rules in the association rules table 400.

Afterwards, the data category calculation processing section 112 makes the confidence distance matrix 703, which has the column (the associated destination) label 702 of the confidence matrix 700 as row (the associated source) label 704 and column (the associated destination) label 705. Each value of the confidence distance matrix 703 is calculated by comparing the values of each column of the confidence matrix 700. Here, the distance between the columns is computed by calculating the square root of the square sum of the difference between columns (Euclidean distance) after the values of each line of the confidence matrix 700 are normalized by “0 mean, variance 1”.

Each value of the lower table of FIG. 7 is calculated by using each value of the upper table. For instance, in case that the associated destination is “guest” and the associated source is “general”, “2.9506975” is obtained by calculating the square root of ((1)−(2))²+((4)−(5))²+((7)−(8))², using the values of the upper table. In addition, the numbers in parentheses are numbers assigned to each data of the upper table.

By determining such distances between all the attribute values, the confidence distance matrix 703 is completed and processing which calculates the similarity of the attribute values is finalized. It is shown that the attributes, between which values of the confidence distance matrix 703 are small, are the ones with high similarity.

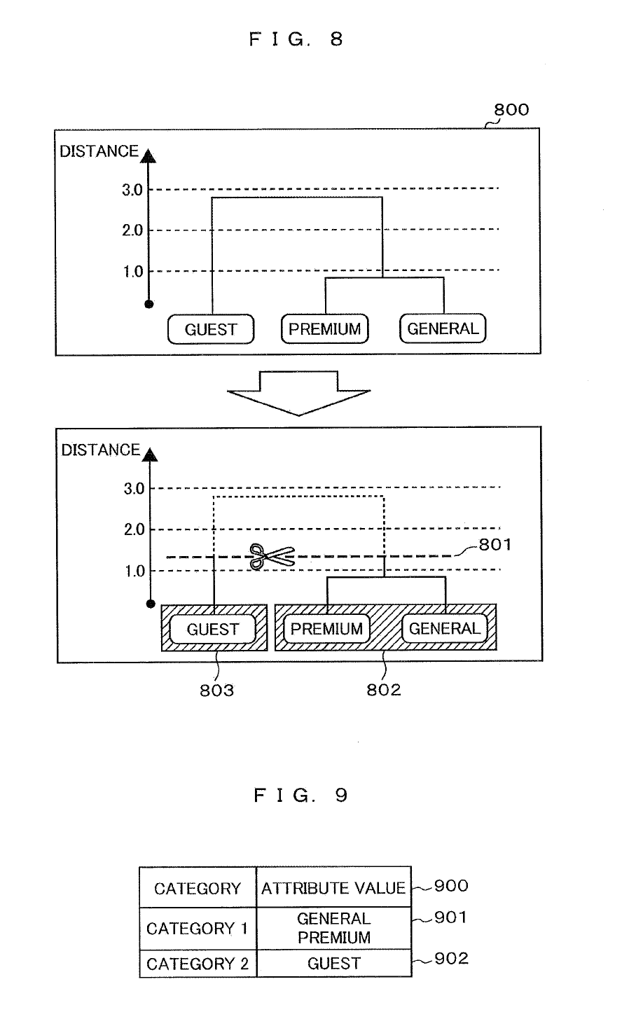

FIG. 8 is an example of an image chart illustrating the processing that brings the attribute values with high similarity of the present embodiment together in the same category.

First, from the confidence distance matrix 703, the data category calculation processing section 112 composes the hierarchical cluster 800. Here, the cluster is composed based on the group average method based on the distance information between the attribute values which the confidence distance matrix 703 maintains. That is, the distance between “premium” and “general” is approximately 0.8 and the distance between “premium”, “general”, and “guest” is approximately 2.9, and these three values are connected respectively. The group average method is a technique for evaluating the distance between a group and a point not included in the group, by the mean value of the distance between the point and each point included in the group. In the group average method, the cluster is mutually made from the members with small distances, and the remaining members otherwise are replaced by the mean value of the distances.

In addition, the data category calculation processing section 112 calculates the distance value 801 to divide the hierarchical cluster 800. Here, it is assumed to calculate the “one-half of the maximum distance in the hierarchical cluster 800” as a method of calculating the distance value 801 to divide the cluster. Value 801 in this example is approximately 1.5.

Thereafter, the data category calculation processing section 112 divides hierarchical cluster 800 according to the value 801. In this example, because value 801 is about 1.5, “premium” and “general” connected by the distance less than it are combined as the same category 802. Since there is no attribute value which is connected with “guest” at a distance not exceeding the value 801, “guest” becomes category 803 composed of a single attribute value.

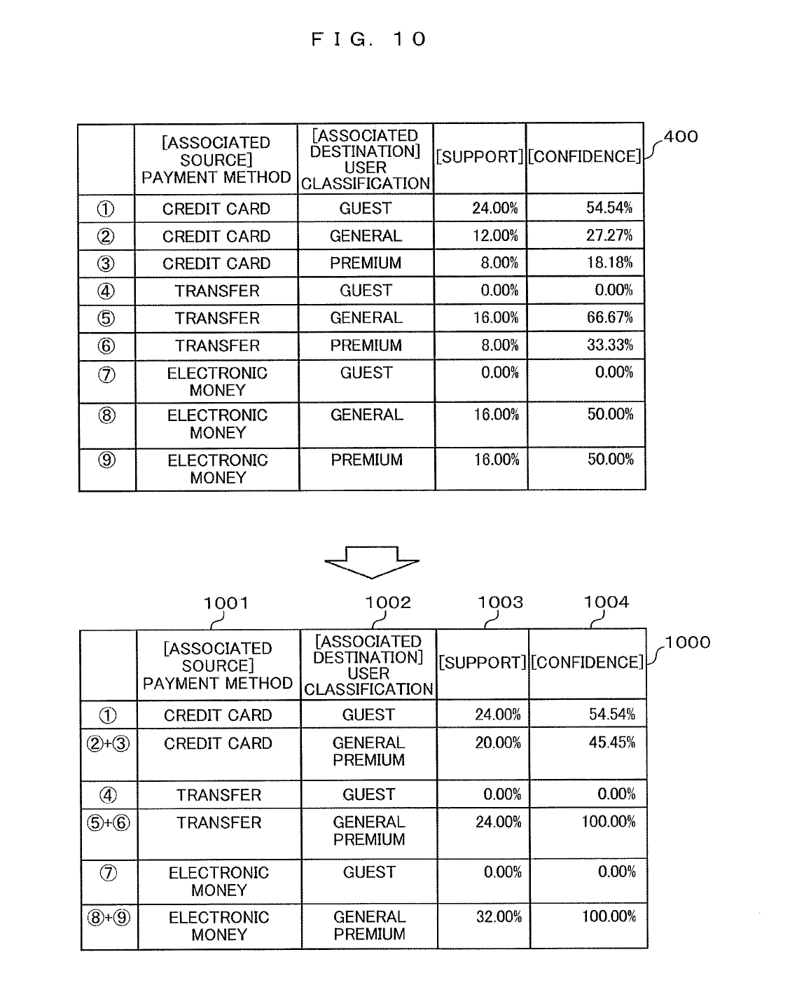

FIG. 9 is an example of an image chart where it explains the result of combining the attribute values with high similarity of the present embodiment in the same category.

The data category calculation processing section 112 writes the above-mentioned derived category in the data category storage section 108 as an attribute values categorization method 900. The above-mentioned category 802 corresponds to the information 901 on category 1 of the attribute values categorization method 900, and the above-mentioned category 803 corresponds to the information 902 on category 2 respectively.

If the number of attribute values which are the objects of the categorization is two or less at the stage where Step 202 is begun, the attribute values categorization method 900 is made which classifies each attribute value into another category respectively, and it is written in the data category storage section 108, thereby completing Step 202.

In Step 203, the association rule reconstruction processing section 113 reads the association rules from the association rules tentative storage section 107, and calculates the association rules again while referring to the attribute values categorization method read from the data category storage section 108, and then writes it in the association rule tentative storage section 107.

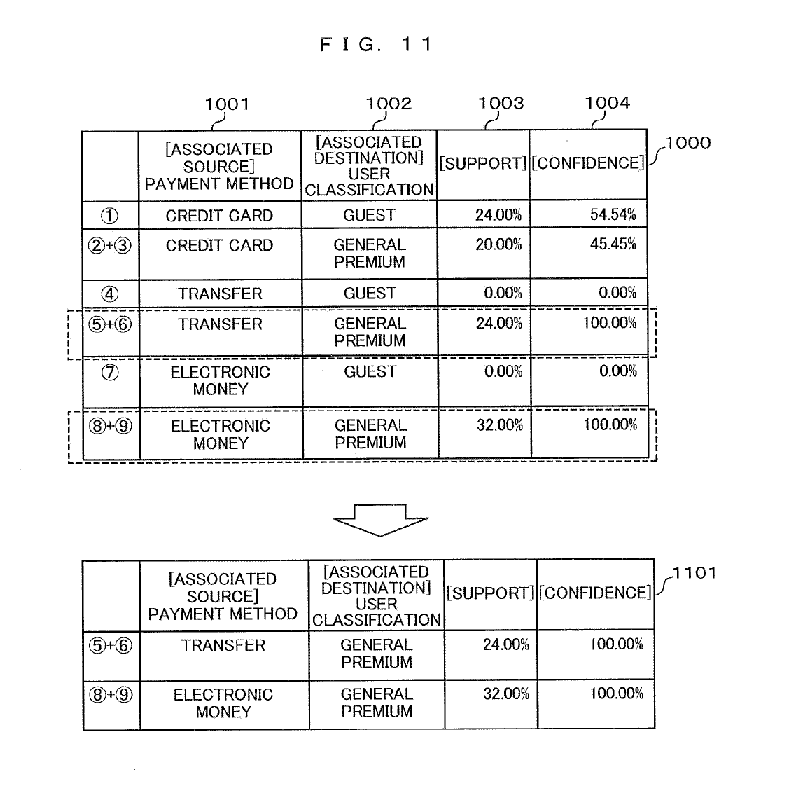

FIG. 10 is an example of an image chart for explaining processing of reconstructing the association rules in the present embodiment.

The association rule reconstruction processing section 113 reads the association rules table 400 of FIG. 6 from the association rules tentative memory section 107, and makes the association rules table 1000 by copying the value of the associated source 401 and the associated destination 402 as a value of the associated source 1001 and the associated destination 1002. However, in the attribute values categorization method 900 which is read from the data category storage section 108, the attribute values included in the same category are assumed to belong to one association rule.

In addition, the association rules reconstruction processing section 113 calculates the value of support 1003 and confidence 1004 of the association rule in the association rule table 1000 from the value of support 403 and confidence 404 described in the association rules table 400 read from the association rules tentative storage section 107. In the present example, since a plurality of attribute values in the associated destination 402 are entered in one record of the associated destination 1002, it is possible to calculate each of the support 1003 and the confidence 1004 in the association rules table 1000 by computing the sum of the support 403 and the sum of the confidence 404 respectively in the corresponding association rules of the association rules table 400. Step 203 is completed by writing the association rules table 1000 as a calculation result in the association rules tentative storage section 107.

Although, in step 202 and 203 of the present embodiment, only the attribute values of the associated destination in the association rules are categorized, you may categorize the attribute values also with respect to the associated resource by using the same method or another method of categorization.

In step 204, the unnecessary rules removal processing section 114 reads the association rules from the association rules tentative storage section 107 and selects only the association rules whose confidence are higher than the threshold and writes them in the high confidence association rules storage section 109.

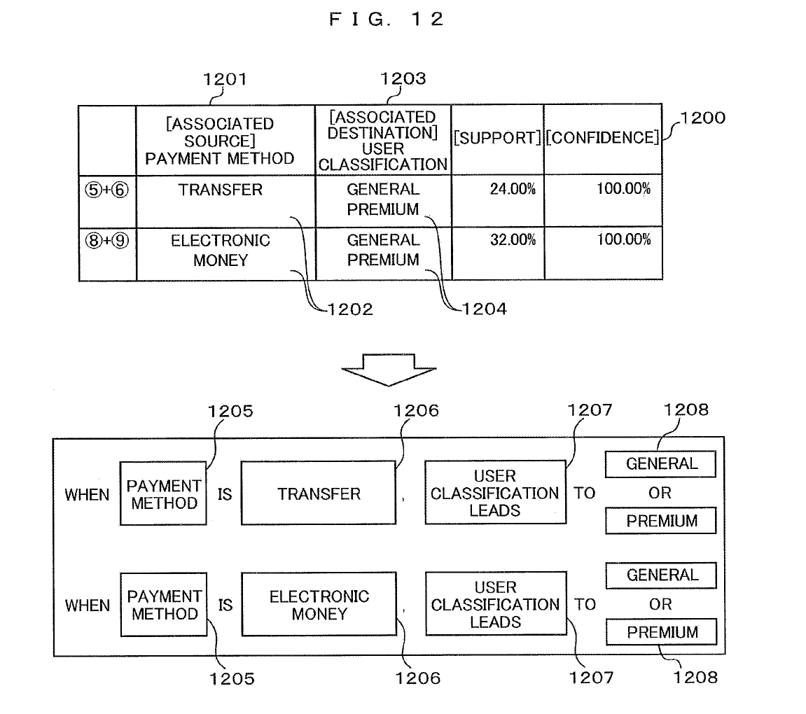

FIG. 11 is an example of an image chart which explains processing that selects the association rules with high confidences of the present embodiment.

Unnecessary rules removal processing section 114 makes a high confidence association rules table 1101 by reading the association rules 1000 from the association rules tentative storage section 107, and among them by extracting an association rules group 1100 with a confidence that is higher than the threshold. In the present example, the threshold of the confidence is assumed to be 95%. Step 204 is completed by writing the high confidence association rules table 1101 to the high confidence association rules storage section 109.

At the time of completion in step 204, when the extraction of the high confidence association rules is completed about the combinations of all the table columns of the table data that the table data storage section maintains, the process proceeds to step 205. If the combinations which do not yet complete the extraction of the high confidence association rules remain, the process returns to step 201 again, and the same processing are done regarding the remaining combinations.

Step 205 is a step where the developer acquires the analysis result of data with the data base analysis apparatus 100 through the output device 104. After the association rules visualization processing section 115 reads the association rules from the high confidence association rules storage section 109 and converts them in an easy format to visually understand, the association rule visualization processing section 115 outputs them to the output device 104. The output may be output as binary data or text data which can be processed by a computer, or may be displayed textually or graphically on a monitor so that the developer can view.

The association rule of almost 100% in the probability of the concurrence is extracted as shown under FIG. 11 by the combinations of the individual association rules shown on FIG. 10, using the processing described above.

FIG. 12 is an example of an image chart illustrating a process of converting, visual data patterns high confidence association rules of the present embodiment, in a readily understandable format. The association rules visualization processing unit 115 reads out one high-confidence association rules table which the high confidence association rules storage section 109 holds. In addition, the association rules visualization processing section 115 outputs the associated source label 1201, the associated source attribute value 1202, the associated destination label 1203, and the associated destination attribute value 1204 of each association rule, that is read, which the high confidence association rules table 1200 maintains respectively, as the associated source name 1205, the associated source attribute value 1206, the associated destination name 1207, and the associated destination attribute value 1208.

Step 205 is completed by performing the process described earlier for the high confidence association rules tables which the high confidence association rules storage section 109 maintains.

Because the confidence of a new association rule becomes almost 100% by reconstructing the association rule again in the present embodiment, the user selects the appropriate one from these association rules while referring to the support. That is, the support is used to judge whether to categorize the association rules newly.

What is claimed is:

1. A database analysis apparatus,
which pays its attention to table columns more than two constituting a table among plural tables that a database holds, and analyzes automatically a dependence and a limitation condition that exist between the table columns from a tendency of appearance at the same time of data which each table column maintains, comprising:
a data category calculation means to calculate a method of categorizing a data group from association rules generated from the data group of two or more table columns; and
an association rules reconstruction means to generate association rules of the best granularity by reconstructing the association rules based on the result of the above categorizing.

2. The database analysis apparatus according to claim 1,
wherein the data category calculation means is a calculation means based on a similarity of the distribution of confidence of the association rules group which contains each data, that table column keeps, as component.

3. The database analysis apparatus according to claim 1,
wherein the database analysis apparatus includes a data category validity calculation means for calculating an index of the validity of each data category.

4. The database analysis apparatus according to claim 1, comprising:
an association rules supplementation means to supplement confidence and support of association rules, not obtained, with appropriate values when the association rules used as input are not obtained concerning each combination of data.

5. The database analysis apparatus according to claim 1, comprising:
an association rule selective extraction means to extract only the association rules which have confidence higher than the definite value among the association rules; and
an association rules visualization means to convert the extracted association rules in an easy format to visually understand as dependence and a limitation condition that exists among the table columns.

6. The database analysis apparatus according to claim 5,
wherein the database analysis apparatus includes an association rules analysis means for performing together the extraction of counter-example of the association rules when they are analyzed; and
wherein the association rules visualization means is a means for converting also the information of the counter-example of the association rules in a format easy to understand visually.

7. The database analysis method,
which, using a computer, pays its attention to table columns more than two constituting a table among the plural tables that a database holds, and analyzes automatically a dependence and a limitation condition that exist between the table columns from a tendency of appearance at the same time of data which each table column maintains, comprising the steps of:
calculating a method of categorizing a data group from the association rules generated from the data group of two or more table columns; and
generating the association rules of the best granularity by reconstructing the association rules based on the result of the above categorizing.

8. The database analysis method according to claim 7,
wherein the step of calculating a method of making a data group category is the calculation step based on a similarity of distribution of confidence of the association rules group that contains each data that table column keeps as component.

9. The database analysis method according to claim 7, comprising:
calculating an index of the validity of each data category.

10. The database analysis method according to claim 7, comprising:
supplementing, confidence and support of association rules, not obtained, with appropriate values when the association rules used as input are not obtained concerning each combination of data.

11. The database analysis method according to claim 7, comprising:
selecting and extracting only the association rules which have confidence higher than the definite value among the association rules; and
converting the extracted association rules in an easy format to visually understand as dependence and a limitation condition that exist among the table columns.

12. The database analysis method according to claim 11, comprising:
performing together extraction of counter-example of the association rules when they are analyzed; and
wherein the step of converting the extracted association rules is a step of converting also the information of the counter-example association rules in a format easy to understand visually.
